(19) United States
(12) Patent Application Publication
(10) Pub. No.: US 2026/0239028 A1
(43) Pub. Date: Aug. 13, 2026

(54) 5G WIRELESS USER EXPERIENCE NETWORK SCORE METRIC

(71) Applicant: T-MOBILE INNOVATIONS LLC, Overland Park, KS (US)

(72) Inventors: Syed Basit AKRAM, Murphy, TX (US); Nicholas Andrew LOCKE, Melissa, TX (US)

(21) Appl. No.: 19/052,999

(22) Filed: Feb. 13, 2025

(51) Int. Cl. H04W 24/02; H04W 24/08

(52) U.S. Cl. CPC H04W 24/02; H04W 24/08

(57) ABSTRACT

Methods for optimizing user experience and network performance are disclosed. The methods involve collecting session-level data from user equipment (UE) including Location Service Records (LSR), which provide detailed performance metrics at the UE level. The data is aggregated into user experience metrics, such as weighted scores or sector-level indicators, are calculated to identify UEs experiencing suboptimal performance. Based on these scores, an optimal technology layer is determined for each identified UE by evaluating factors such as UE capability, operational state, and radio frequency (RF) conditions. The methods include activating the optimal technology layer or maintaining the current layer to improve connectivity and resource utilization. The described methods dynamically adapt to real-time network conditions, and various network configurations, ensuring efficient resource allocation and consistent user experiences.

### SUMMARY

The present disclosure is directed to methods for enabling optimization of user experience and user device performance based on user equipment (UE) capability such as supported network technologies.

According to various aspects herein, this disclosure describes methods and systems for optimizing user experience and network performance by dynamically analyzing user equipment (UE) capabilities, operational states, and radio frequency (RF) conditions. The methods include collecting session-level data, such as Location Service Records (LSR), aggregating it into user experience metrics, calculating weighted scores to identify UEs experiencing suboptimal performance, determining optimal technology layers for the identified UEs, and activating technology layers or retaining existing layers based on the determination. These methods and systems provide a dynamic and adaptive approach to enhancing connectivity and resource utilization in diverse wireless network environments.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Implementations of the present disclosure are described in detail below with reference to the attached drawing figures, wherein:

FIG. 1 illustrates a network environment in which implementations of the present disclosure may be employed;

FIG. 2 illustrates preferred operation mode based on user equipment (UE) capability in accordance with aspects herein;

FIG. 3 illustrates the selection of preferred and non-preferred connections in accordance with aspects herein;

FIG. 4 illustrates data collected at the session level, including UE capability and RF conditions in accordance with aspects herein;

FIG. 5 illustrates a process for determining the capability of a UE based on its session details in accordance with aspects herein;

FIG. 6A illustrates a process for assigning a UE penalty score in accordance with aspects herein;

FIG. 6B illustrates a process for assigning an RF penalty score to UE in accordance with aspects herein;

FIG. 7 illustrates a process for calculating a Subscriber Experience Score in accordance with aspects herein;

FIG. 8 illustrates a process for calculating a Sector Experience Score in accordance with aspects herein;

FIG. 9 depicts a flow diagram of a method for use with aspects of the disclosure described herein;

FIG. 10 depicts a flow diagram of a method for use with aspects of the disclosure described herein;

FIG. 11 depicts a flow diagram of a method for use with aspects of the disclosure described herein; and

FIG. 12 illustrates a computing device suitable for use with implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” is used to refer to network access technology for the provision of wireless telecommunication services from a base station to one or more electronic devices, such as an eNodeB, gNodeB, etc. The term “cell” is used to describe one or more hardware and software components of a base station that are configured to provide wireless communication service to a geographic area.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the latest advancements in 5G technology have enabled devices to operate across various network modes such as NR (New Radio), LTE (Long-Term Evolution), UMTS (Universal Mobile Telecommunications Systems), and GSM (Global System for Mobile Communications). The choice of a network mode is influenced by network configurations and radio frequency (RF) conditions, which directly impact user experience and network resource efficiency. A significant challenge lies in aligning device capabilities with network performance, a key factor in optimizing quality of service (QoS). Furthermore, conventional big data analysis often reduces data granularity during aggregation process, resulting in missed insights critical to actionable improvements in network performance.

Conventionally, the migration of wireless spectrum from older technologies to newer layers has been a challenge as the wireless technology evolved through generations from GSM to NR. To address this, the introduction of Non-Stand Alone (NSA) mode in NR technology allowed devices to use both legacy and new network layers simultaneously, thereby mitigating the immediate need for spectrum migration. However, NSA mode exhibits limitations, including reduced efficiency and inconsistent user experiences compared to the Stand Alone (SA) mode. Current solutions fail to provide a robust mechanism to align device operation state or mode with their best capabilities, leaving SA-capable devices underutilized in NR networks.

Unlike conventional solutions, the present disclosure leverages NR's advanced Location Service Records (LSR) to enhance network analysis at the device level by capturing device-specific layer 2/3 statistics. By aggregating and analyzing this data as described, a network solutions provider may achieve precise identification of a particular user equipment (UE) at different technology layers, and corresponding RF conditions. This information may be used to ensure SA-capable devices are placed optimally in SA mode for optimal user experience and network efficiency. Additionally, LSR data offers a detailed view of RF conditions across cells, which may further enable the optimal selection of a primary cell. This ensures stable communication paths and efficient network resource allocation, including determining optimal technology layers. This granular approach not only preserves the integrity of big data but also transforms it into actionable insights, allowing for targeted optimizations in UE placement and network configuration. The present disclosure introduces methods highlighting network deficiencies to further optimize user experience and device performance by leveraging these insights.

Accordingly, a first aspect of the present disclosure provides a method for enabling optimization of user experience and user device performance. The method comprises collecting data from one or more user equipment (UEs), the data corresponding to UE capability information, UE operational state, and RF conditions. The method further comprises aggregating the collected data into user experience metrics. The method further comprises identifying at least one UE of the one or more UEs with user experience metrics below a predetermined threshold. The method further comprises based on the user experience metrics being below the predetermined threshold, determining an optimal technology layer for the at least one UE. The method further comprises activating the optimized technology layer for the identified at least one UE.

A second aspect of the present disclosure provides a method for enabling optimization of user experience and user device performance. The method comprises collecting data from one or more user equipment (UEs), the data corresponding to UE capability information, UE operational state, and RF conditions. The method further comprises aggregating the collected data into raw user experience metrics. The method further comprises based on the raw user experience metrics, calculating a weighted score for each of the one or more UEs. The method further comprises identifying at least one UE of the one or more UEs with a weighted score above a predetermined threshold. The method further comprises based on the weighted score being above the predetermined threshold, determining an optimal technology layer for the identified at least one UE. The method further comprises activating the optimized technology layer for the identified at least one UE.

Another aspect of the present disclosure is directed to a method for enabling optimization of user experience and user device performance. The method comprises collecting data from a plurality of user equipment (UEs) operating within a network sector, the data corresponding to UE capability information, UE operational state, and RF conditions. The method further comprises calculating a weighted score for each UE within the network sector. The method further comprises identifying one or more UEs within the network sector having a weighted score exceeding a predetermined threshold. The method further comprises determining an optimal technology layer for the each UE of the one or more UEs within the network sector having a weighted score exceeding a predetermined threshold. The method further comprises based on the determination of an optimal technology layer for each UE of the one or more UEs within the network sector having a weighted score exceeding a predetermined threshold, activating a technology layer.

With the evolution of the wireless technology from GSM to NR, determining the optimal points for migrating wireless spectrum from older technology layers to newer ones presents an ongoing challenge. The quality of the connection between the user and the network is influenced by the available spectrum and prevailing RF conditions, which together define the performance and efficiency of the network.

The latest NR technology, 5G, addresses this challenge by enabling newer devices to operate simultaneously on both new and legacy technologies, reducing the immediate need for spectrum migration. This approach introduced a new subset mode of NR operation, Non-Stand Alone (NSA), which works alongside existing modes such as LTE and NR. However, to achieve optimal quality of service (QoS) and efficient network resource utilization, NR-capable devices should ideally operate in Stand Alone (SA) mode, relying exclusively on the NR technology layer.

In a hybrid network comprising multiple technologies, optimal utilization of network resources and the best possible user experience may best be achieved by aligning UE with the operational mode that matches its highest capability. Specifically, the latest UE devices capable of SA operation should be served in SA mode, rather than legacy modes such as GSM, UMTS, or LTE. Furthermore, in a mature 5G network, placing an SA-capable device in NSA mode is inefficient, as NSA mode provides lower efficiency and a less consistent user experience compared to SA mode.

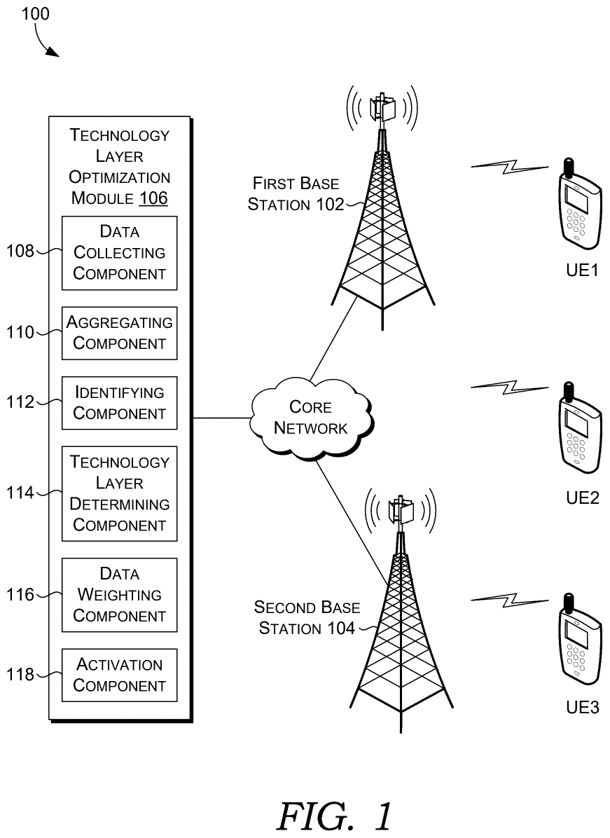

Referring to FIG. 1, a representative network environment is illustrated in which implementations of the present disclosure may be employed. Such a network environment is illustrated and designated generally as network environment 100. At a high level the network environment comprises UE 1, UE2, and UE3 configured to wirelessly communicate with the one or more base stations of the network environment, first base station 102 and second base station 104, which are both connected to a core network, and a network technology layer optimization module 106. The technology layer optimization module 106 includes a data collecting component 108, an aggregating component 110, an identifying component 112, a technology layer determining component 114, a data weighing component 116, and an activation component 118.

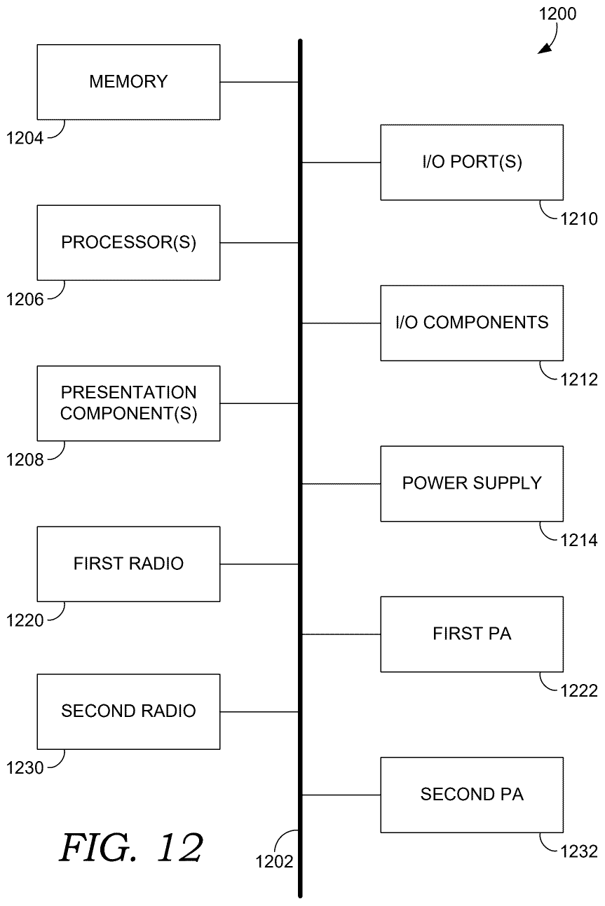

The UE of the network environment 100 may take on a variety of forms, such as a personal computer (PC), a user device, a smart phone, a smart watch, an extended reality (XR) device, Internet of Things (IoT) device, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device that comprising any one or more feature of computing device 1200 of FIG. 12.

The data collecting component 108 is generally responsible for gathering network-related data. The data collecting component 108 may collect data from one or more UEs. The data may be collected from one or more UEs operating within a network sector. With the radio access standard specified for 5G by the 3^{rd} Generation Partnership Project (3GPP), the ability to analyze such data has been significantly enhanced. Specifically, the latest NR standard introduced Location Service Records (LSR), a functionality that records UE-specific layer 2/3 statistics. The LSR data provides granular insights into UE-specific performance, including RF conditions and operational state. This data enables operators to analyze network operation at the UE level, a substantial improvement over traditional methods that offered only aggregated statistics at the network node level.

The data collecting component 108 may identify and collect LSR data which correspond to UE capability information. For example, the data collecting component 108 may be used to identify and collect data indicating the operation of a particular UE at different technology layers, referred to herein as UE operational state or operational mode. The data collecting component 108 may also be used to identify RF conditions, also referred to herein as RF mode, corresponding to the UE operational mode. For a certain UE, the combination of operational mode data and RF conditions data may be used to assess customer experience and identify opportunities to allocate additional resources based on UE capability and network configuration.

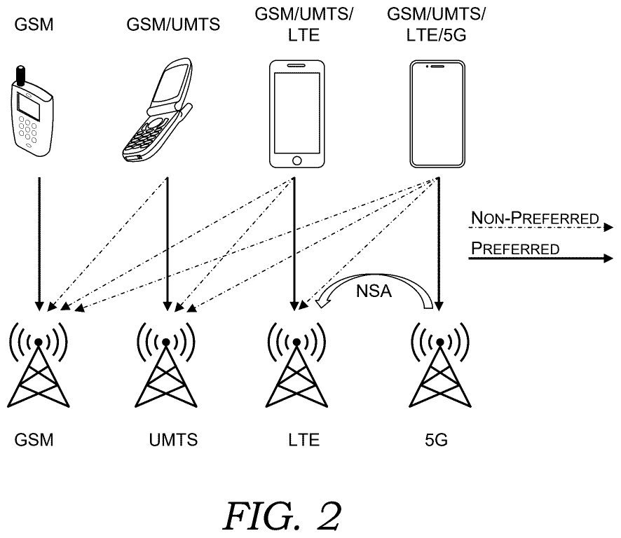

Understanding the UE operational mode of UE is critical to optimizing network performance and resource utilization. Placement of a UE in its optimal operational mode may ensure better throughput, a stable connection, and minimal usage of network resources. Moreover, serving the UE in the correct operational mode enables network operators to align available bandwidth resources with the penetration of UEs supporting various network technologies, optimizing both performance and resource allocation. Base stations and devices are designed to maintain backward compatibility with older technologies, ensuring seamless operation across multiple generations of network layers. Turning now to FIG. 2, the preferred operational mode for UEs based on their technological capabilities, corresponding network configurations, and available spectrum resources is illustrated. FIG. 2 illustrates the progression of device compatibility across network layers, from legacy GSM-only devices to modern 5G-compatible devices. GSM-only devices connect exclusively to GSM base stations, whereas devices supporting GSM/UMTS or GSM/UMTS/LTE may access additional network layers, providing expanded connectivity options. The most advanced devices, which support GSM/UMTS/LTE/5G, are capable of operating in both SA and NSA modes. These devices prioritize connecting to 5G network layers for optimal performance, leveraging their advanced capabilities. FIG. 2 illustrates the distinction between preferred and non-preferred connections using solid and dashed arrows, respectively. Non-preferred connections, while available, are less efficient compared to preferred connections, which align with the device's highest capabilities and network design.

As newer technologies are introduced, such as through updated network nodes and UEs, they are initially allocated limited resources due to lower device penetration. However, network configurations prioritize placing the majority of newer devices on the latest technology layers, enabling more efficient utilization of available spectrum. This prioritization is managed through the careful allocation of bandwidth, with operators dynamically adjusting spectrum distribution based on the capabilities of the UE base and growing customer adoption of advanced technologies. By ensuring UEs operate in their preferred modes and optimizing spectrum allocation, network operators may maximize resource efficiency and deliver consistent, high-quality user experiences.

In addition to understanding the UE operational mode, it is equally important to consider the RF conditions, under which UE operate. RF conditions reflect the radio frequency environment experienced by the UE, which directly impacts the quality and stability of its connection to the network. By understanding RF conditions alongside UE operational mode, networks may better optimize resource allocation and enhance overall performance. This dual focus ensures that devices not only operate in their most capable modes, but under the most favorable RF conditions for consistent and efficient communication.

LSR provide Synchronization Signal Reference Signal Received Power (SS-RSRP) measurements for the primary cell to which a UE is connected. The primary cell is responsible for carrying control traffic, and SS-RSRP is a key metric used in 5G networks to evaluate the received signal strength of synchronization signals transmitted by a base station. Specifically, SS-RSRP measures the signal strength of the primary and secondary synchronization signals, which are essential for the UE to synchronize with the base station and establish reliable uplink and downlink communication. When a UE connects to an NR cell as its primary cell, both uplink and downlink communication paths are established through the same cell to support control traffic. Stable control traffic communication is vital for maintaining a reliable network connection. At any given location, a UE may detect multiple network cells operating at different frequencies and RSRP levels. Selecting the optimal primary cell ensures consistent user experiences and efficient utilization of network resources.

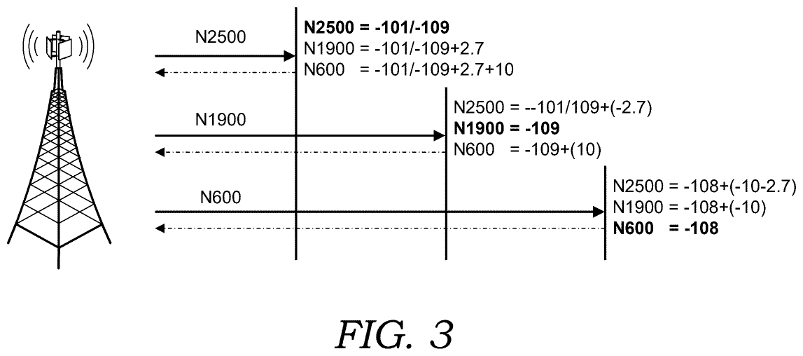

Turning now to FIG. 3, an example of signal strength thresholds and the preferred/non-preferred connections across multiple frequency bands in a wireless network is shown. Specifically, FIG. 3 depicts three frequency bands—N2500, N1900, and N600—alongside their respective SS-RSRP levels. Preferred connections, indicated by solid arrows, align UEs with the most suitable network frequency band and operational mode based on their capabilities and prevailing RF conditions, ensuring optimal performance and efficient resource utilization. In contrast, non-preferred connections, shown with dashed arrows, represent less efficient alternatives that may be used when preferred connections are unavailable. FIG. 3 provides an example for how UEs prioritize connections to various frequency bands based on signal strength thresholds. This information may be used to guide decision making by the activation component 118, such as dynamically transitioning UEs to alternate, optimal technology layers based on RF conditions and user metrics. The example depicted in FIG. 3 illustrates signal strength thresholds and preferred or non-preferred connections across specific frequency and (e.g., N2500, N1900, N600). It should be understood that these frequency bands and thresholds are provided herein as examples and are not intended to be limiting. The methods described herein may be applied to other frequency bands, signal strength ranges, or network configurations as required by the operator's deployment and network environment.

In a typical wireless network, different spectrums and frequencies are allocated to various technology layers, such as NR and LTE, to support diverse device capabilities and usage scenarios. Signal propagation in wireless communication is inversely proportional to frequency, meaning lower frequencies may cover greater distances, while higher frequencies provide short range but greater capacity. At a given location, a stronger signal results in a higher Signal-to-Noise Ratio (SINR), which improves the quality of the link and enables higher data transmission rates or throughput. The SS-RSRP measurement may therefore be utilized to assess downlink throughput by determining the strength of the signal received by the UE. This information plays a crucial role in optimizing user experience by aligning UEs with the frequency bands and operational modes that best match their capabilities.

The capacity of a wireless channel is primarily defined by assigning bandwidth and the distribution of power across its Radio Resource Blocks (RRBs). Effective channel utilization requires uniform power allocation across all RRBs, with the number of RRBs being proportional to the channel's bandwidth. Larger bandwidth channels with a greater number of RRBs require higher power levels to maintain consistent power density. While achieving uniform power distribution is relatively straightforward in the downlink direction, uplink power is constrained by UE capabilities. Most UEs are class 3 devices with a maximum transmission power of 23 dBm (200 mW), limiting their ability to maintain balanced uplink and downlink communication paths. This imbalance, quantified through link budget calculations, is represented as Maximum Allowed Path Loss (MAPL). Proper management of these constraints ensures efficient utilization of wireless resources and supports consistent, high-quality connections across all technology layers.

The LSR data collected by the data collecting component 108 may be collected at the session level, encapsulating a wide range of information for each session. This includes sessions conducted in Wi-Fi mode with minimal connectivity to the LTE network, primarily to update the device's location within the wireless network. Because the LSR data is collected by the wireless network without explicit indication of the UE utilizing Wi-Fi______33 mode, these sessions are tagged by decoding the Quality of Service Class Identifier (QCI) information in the LSR data. The tagging and decoding of the QCI information in the LSR data may be performed by the aggregating component 110. Specifically, the aggregating component may tag QCI values 6, 7, 8, and 9 as data sessions, while QCI values 1 and 5, along with the remaining QCIs, may be tagged for voice connections. The system may behave differently for voice calls, and therefore, these sessions are filtered by the aggregating component 110 for further analysis.

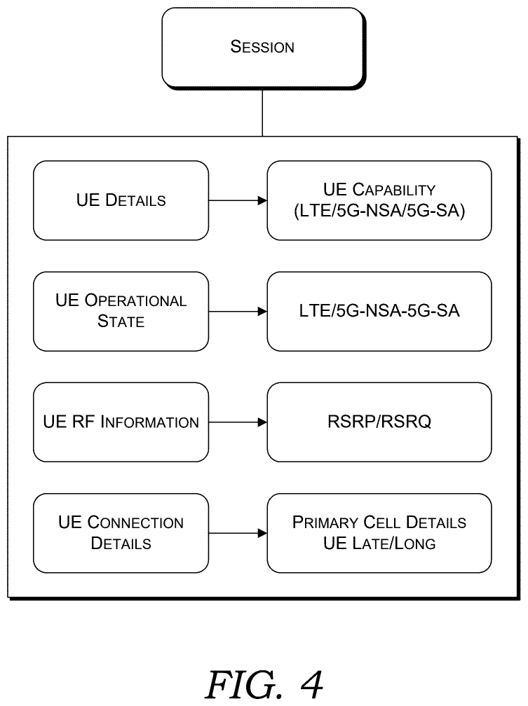

Turning now to FIG. 4, a flow chart depicting examples of LSR data that may be collected by the data collecting component 108 at the session level is illustrated. The flow chart organizes the data collected by the data collecting component 108 into four key categories: UE details, UE operational state or operational mode, UE RF information, and UE connection details, each of which provides specific information essential for optimizing network performance. UE details includes data related to the UE's capability, specifically its capability to operate on different network technologies such as LTE, 5G-NSA, or 5G-SA. The UE operational mode or the session technology mode includes data related to the operational mode of the UE, and indicates the specific technology later in use during a session for each individual UE. The UE operational mode may be different from the UE capability. The possible options are SA, NSA, SA600 and LTE. As described herein, the LSR data is collected by the data collecting component 108 at the session level.

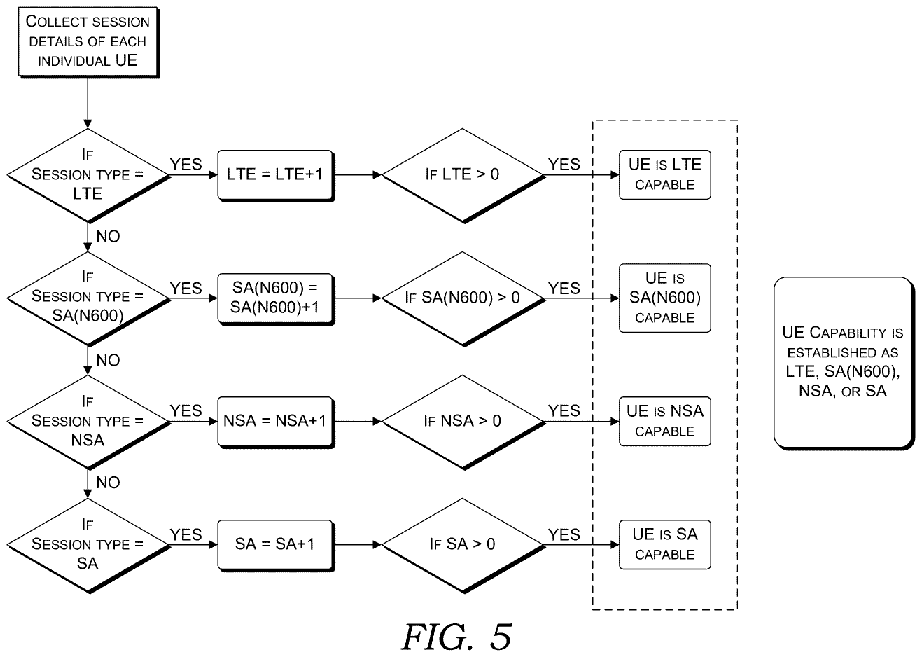

Turning now to FIG. 5, a process for determining the capability of a UE based on its session details is illustrated. The chart outlines how session data collected for individual UEs may be analyzed in accordance with aspects herein to classify the UE's technology capabilities across various network layers. The process begins by collecting session details for each UE, including the type of session the UE is operating in (e.g., LTE, SA on N600, NSA, or SA). This may be performed by the data collecting component 108, which may ensure the raw data necessary for the analysis is available for processing. The type of session the UE is using is evaluated and counted or incremented. This may be performed by the aggregating component 110. If the session type is LTE, a counter for LTE capability is incremented. If the session type is SA(N600), a counter for SA(N600) is incremented. If the session type is NSA, a counter for NSA capability is incremented. If the session type is SA, a counter for SA capability is incremented. The counters are checked to determine if they are greater than zero. If LTE>0, the UE is classified as LTE capable. If SA(N600)>0, the UE is classified as SA(N600) capable. If NSA>0, the UE is classified as NSA capable. If SA>0, the UE is classified as SA capable. Based on the session data and the evaluations, the UE is assigned one or more capabilities, such as LTE, SA(N600), NSA, or SA. This may be performed by the identifying component 112, which may identify whether a UE qualifies as being capable of a particular technology layer based on aggregated session data. The identifying component may compare the session counters to determine UE capabilities. The technology layer determining component 114 may then establish the maximum capability of the UE based on its aggregated session data and classifications. In other words, the information identified by the identifying component 112 may be used by the technology layer determining component 114 to determine the most advanced technology layer the UE supports.

The aggregating component 110 may analyze each UE session individually, and the different types of operation modes may be counted across multiple UE sessions. By monitoring the operation modes of the sessions, the aggregating component 110 may determine the maximum capability of a particular UE, or the UE details. For example, as illustrated in FIG. 5, if a UE has SA=0 at the end of the scanning but NSA>0, the maximum capacity of the UE is identified as NSA. In this scenario, the UE will not be penalized for operating in the NSA operation mode. Additionally, most UE vendors provide user settings to limit the maximum capability of the UE in case the user experiences issues with the maximum capability, such as with NR technology. This aggregated data compiled by the aggregating component 110 helps in accurately determining the optimal operation mode for each UE. The data weighing component 116 may additionally assign weighted importance to certain session types (e.g., prioritizing SA sessions over LTE sessions) to influence the final determination of the UE's maximum capability.

Returning to FIG. 4, The UE RF information includes data related to the basis RSRP and Reference Signal Received Quality (RSRQ) information of the session for each UE. The UE connection details includes data related to a UE's connection to the network. It includes the Physical Cell ID (PCI), Absolute Radio Frequency Channel Number (ARFCN), and base station information (e.g., eNodeB for LTE or gNodeB for NR). The LSR data in its raw format provides these details, which are then aggregated and mapped by the aggregating component to the operator-specific network for easier interpretation by engineers. The combination of PCI and ARFCN allows identification of the technology layers in use. Additionally, the latitude longitude data is included in the UE connection details. This data may be used to calculate the distance between one or more base stations and a UE, providing valuable spatial insights for network optimization.

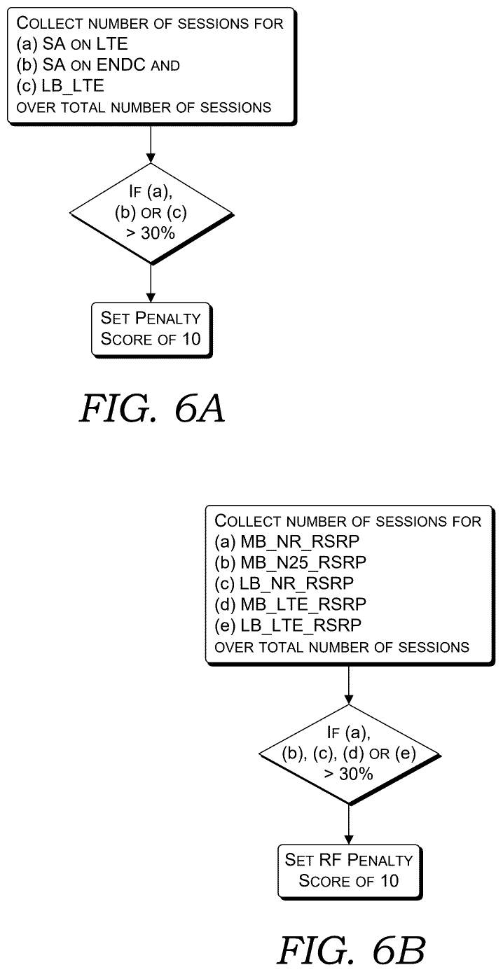

Basic UE scoring may be determined based on two main criteria, the operation state (e.g., SA, NSA, SA600 and LTE), as depicted in FIG. 6A and the RF state, as depicted in FIG. 6B. For the first criteria, a penalty score is determined. The penalty score reflects suboptimal performance due to mismatched technology layers or poor RF conditions. This penalty score may indicate the proportion of sessions where UEs operate in suboptimal technology modes, and may indicate poor operational state performance. The penalty score is assigned to UEs that may be spending significant time in non-preferred technology layers to flag them for possible transitions to more advanced layers. As illustrated in FIG. 6A, the process for assigning a UE penalty score may begin by collecting, by the data collecting component 108, the number of sessions for a UE in the following categories: (a) SA on LTE, (b) SA on EN-DC (Evolved-Universal Terrestrial Radio Access Dual Connectivity), a hybrid LTE/5G configuration, and (c) LB_LTE (Load-Balanced LTE), where the UE is placed on LTE due to load balancing even though it may be capable of using 5G. These sessions are compared to the total number of sessions for the UE. The aggregating component 110 may be responsible for aggregating the session counts and calculating the proportion of sessions in suboptimal modes. The identifying component 112 may then evaluate whether the proportion of sessions in any of the suboptimal conditions (categories (a), (b), or (c)) exceeds 30% of the total sessions. If the threshold is exceeded (i.e., more than 30% of sessions are spent in these suboptimal modes), the UE is assigned a penalty score of 10. The technology layer determining component 114 may then use the penalty score, or a pass fail condition, to prioritize UEs for transition to optimal technology layers.

In the above example, the combination of “SA on LTE,” “SA on ENDC,” and “LB_LTE over Total Session” are considered for this analysis. However it should be understood that these are merely example technology layers specific to this implementation, and the described method is not limited to these layers. This analysis may be extended to include other technology layers or modes based on the network configurations of other operators. Additionally, in the above example, a base filter of fifty sessions is used to ensure a sufficient number of samples before making the PASS/FAIL decision for the UE, and an example timeframe of thirty (30) days is considered for the analysis. However, it should be understood that base filter value and the analysis timeframe are merely illustrative and are not intended to be limiting. The base filter of 50 sessions may be adjusted based on the network operator's requirements, the expected user activity levels, or the statistical significance needed for reliable analysis. Similarly, the timeframe for analysis may vary and may be set to shorter or longer periods depending on the context, such as network load patterns, user mobility, or operational goals. The described analysis framework is therefore intended to be broadly applicable and customizable to suit diverse network setups and operational requirements.

Turning now to FIG. 6B, a chart depicting a process for assigning an RF penalty score to a UE based on the proportion of sessions in which it may experience poor RF conditions across multiple network configurations is shown. The RF penalty score may quantify poor RF performance by monitoring specific conditions across various network layers and frequency bands. The RF penalty score may be used to prioritize UEs experiencing degraded RF conditions for further analysis or optimization. By focusing on specific RF metrics (RSRP) across different frequency bands and technology layers, the RF score may assist in identifying UEs with consistent performance issues. As illustrated in FIG. 6B, the process may begin with the data collecting component 108 by collecting the number of sessions where the UE may experience poor RF conditions across the following categories: (a) MB_NR_RSP, which are mid-band (NR) sessions with low RSRP, (b) MB_N25_RSRP, which are mid-band NR sessions on N25 frequency band with low RSRP, (c) LB_NR_RSRP, which are low-band NR sessions with low RSRP, (d) MB_LTE_RSRP, which are mid-band LTE sessions with low RSRP, and (e) LB_LTE_RSRP, which are low-band LTE sessions with low RSRP. The aggregating component 110 may calculate the proportion of sessions with poor RF performance by comparing the number of sessions with poor RF performance to the total number of UE sessions. The identifying component 112 may evaluate whether the proportion of sessions in any of these poor RF conditions exceeds a predetermined threshold of, for the example used here, 30% of the total sessions. If the predetermined threshold is exceeded (i.e., more than 30% of sessions are in poor RF conditions), the UE is assigned an RF penalty score of 10. The technology layer determining component 114 may determine whether the UE should be transitioned to an optimal technology layer with better RF conditions.

In the above example, the RF penalty score is calculated by monitoring the proportion of sessions in specific RF conditions, such as MB_NR_RSRP, MB_N25_RSRP, LB_NR_RSRP, MB_LTE_RSRP and LB_LTE_RSRP, with a predetermined threshold of 30%. However, it should be understood that these specific RF conditions, frequency bands, and thresholds are provided as examples and are not intended to be limiting. The disclosed method may be applied to other RF metrics, such as SINR, or RSRQ, and to other frequency bands or network configurations based on the operator's deployment. Additionally, the threshold of 30% may be adjusted dynamically or set to higher or lower values depending on the statistical significance required, the desired network performance, or operator defined QoS criteria. The method disclosed herein is intended to be adaptable to different RF environments, network technologies, and operational goals to ensure flexibility across diverse wireless network implementations. “Bad RF conditions” as used herein may refer to conditions where the radio frequency environment negatively impacts the performance of the UE. This may include factors such as low signal strength, as measured by RSRP, where the signal strength is below a predetermined threshold, indicating poor reception. For example, bad RF conditions may refer to sessions where the RSRP levels are below the Minimum Acceptable Performance Level set thresholds. In other examples, bad RF conditions may refer to sessions where QoS metrics are below a predetermined threshold. This may also include factors such as high interference levels, as measured by SINR or RSRQ, where inference levels are above a certain threshold, and high interference degrades the quality of the received signal. This may also include factors such as high packet loss, where the percentage of data packet loss during transmission is above a certain threshold, which may indicate poor network conditions. This may also include factors such as high latency and jitter. Significant delays and variations in packet transmission times, affecting real-time communication and overall user experience may be above a certain threshold.

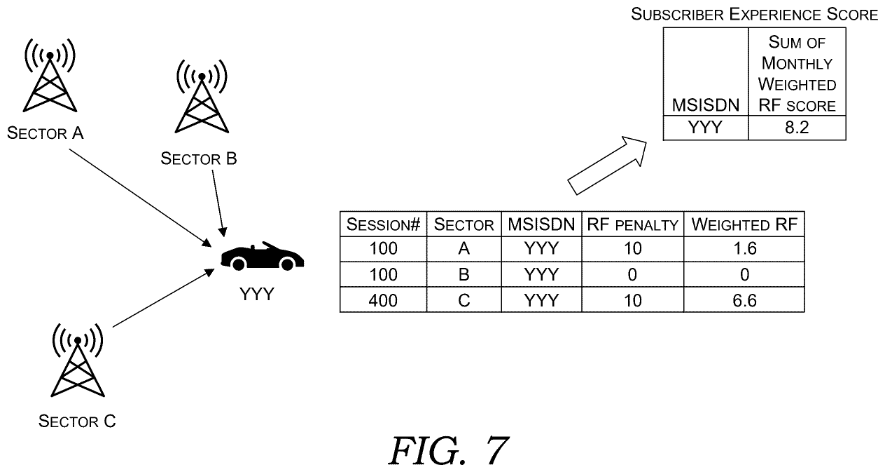

In a wireless network, a UE may attach to multiple base stations and corresponding sectors depending on its location at different times. To accurately capture the total user experience, the RF score of a UE at each individual session may be converted into a weighted score based on the number of sessions the UE exercised on different sectors. As depicted in FIG. 7, the aggregating component 110 may convert the raw RF score into a weighted RF score to ensure a comprehensive assessment of the UE's performance across multiple sectors. The weighted RF score for a particular sector may be calculated using the formula: Weighted RF score at a Sector A=penalty score×(session on Sector A/total sessions on Sector A+SectorB+SectorC). This approach ensures that the score reflects the UE's performance across various sectors, providing a more comprehensive assessment of the user experience.

The weighted score, also referred to as the Subscriber Experience Score, defines the percentage of sessions in which the UE experienced poor RF conditions. By aggregating the weighted scores at the UE or sector level, the identifying component 112 may calculate the total UE experience and/or identify sectors serving a significant number of UEs with poor experiences. When the weighted score is summed for a particular UE, the total score may indicate the percentage of time the UE experienced poor RF conditions. For example, as shown in FIG. 7, if the subscriber UE “YYY” receives a score of 8/2, 82% of the time the subscriber UE's primary cell connection occurred on a technology layer with RSRP levels below a threshold. Such a high score may indicate a significant probability of the subscriber UE experiencing an unstable wireless connection, proportional to the actual values measured by RSRP. The predetermined threshold for the weighted score may be dynamically adjusted based on real-time network metrics or conditions. For example, during periods of high sector congestion, the threshold may be lowered to identify a greater number of UEs experiencing degraded performance, enabling more targeted optimizations. Alternatively, during periods of low network load, the threshold may be raised to focus on UEs with the most significant performance issues. This dynamic adjustment ensures that the weighted scores remain reflective of the current network environment and align with the operator's performance objectives.

The data weighing component 116 may incorporate a user impact analysis by considering factors such as user location, frequency of use, and duration of connection. For example, users in residential areas with frequent network usage may be weighted more heavily than users in transient locations, such as retail spaces or temporary gathering points. By incorporating these metrics into the calculation of Subscriber Experience Scores, the system may prioritize users and locations with the highest potential for improving overall network perception and service quality.

Based on the weighted Subscriber Experience Score being below a predetermined threshold, the technology layer determining component 114 may determine an optimal technology layer for the identified UE. The determination may take into account the UE's capability, network configuration, and RF conditions, enabling selection of a technology layer that provides the best possible user experience. The data weighing component 116 plays a critical role in ensuring that the weighted RF score accurately reflects the UE's performance across multiple sectors, enabling precise adjustments to the technology layer assignment. Once the optimal technology layer is determined, the activation component 118 may activate the determined technology layer for the identified UE, thereby improving its connection stability and overall experience. For example, a UE experiencing unstable connections on LTE may be transitioned to a 5G-NSA or 5G-SA layer, depending on its capabilities, to achieve better throughput and network performance. The data weighing component 116 may dynamically adjust predetermined thresholds based on overall network performance metrics. For example, in scenarios where sector congestion exceeds a predefined limit or average SINR values fall below an acceptable range, the thresholds for weighted scores may be lowered to identify UEs experiencing degraded performance more effectively.

The technology layer determining component 114 may utilize a combination of UE capability, RF conditions, and operational state metrics to determine the optimal technology layer for the identified UE. For example, the technology layer determining component 114 may compare uplink and downlink signal strength thresholds (e.g., SINR, RSRP) to assess whether transitioning from a current technology layer, such as LTE, to an advanced layer like 5G-NSA or 5G-SA would improve user experience by ensuring UEs are served on the most appropriate technology layer. This process may also consider network-wide factors such as available bandwidth and sector congestion to ensure balanced resource utilization. The technology layer determining component 114 may also consider contextual information such as user location and usage patterns to determine the optimal technology layer for a given UE. For example, users in high-impact areas, such as densely populated neighborhoods or residential buildings, where a subscriber spends the majority of their time and which play a larger role in each individual users'lifetime perception of the network, may be prioritized for transitions to higher-performing technology layers like 5G-SA. Conversely, areas with transient or lower-impact usage, such as retail centers or public gathering spots, with the most “bad” experience users, but where subscribers do not spend much time, may receive lower priority for advanced technology layers, allowing resources to be allocated where they are most needed to optimize long-term user experience metrics.

Activating the optimal technology layer for a UE may involve further network considerations. For example, a UE operating on LTE with poor RF conditions may be transitioned to 5G-NSA if it offers better coverage and performance. Conversely, UEs operating on 5G-NSA in a congested sector may be transitioned back to LTE if it provides a more stable connection. Additionally, in areas with strong 5G-SA coverage, the activation component 118 may prioritize transitions to 5G-SA to leverage its higher throughput and lower latency capabilities. These transitions are performed dynamically, ensuring minimal disruption to the user experience.

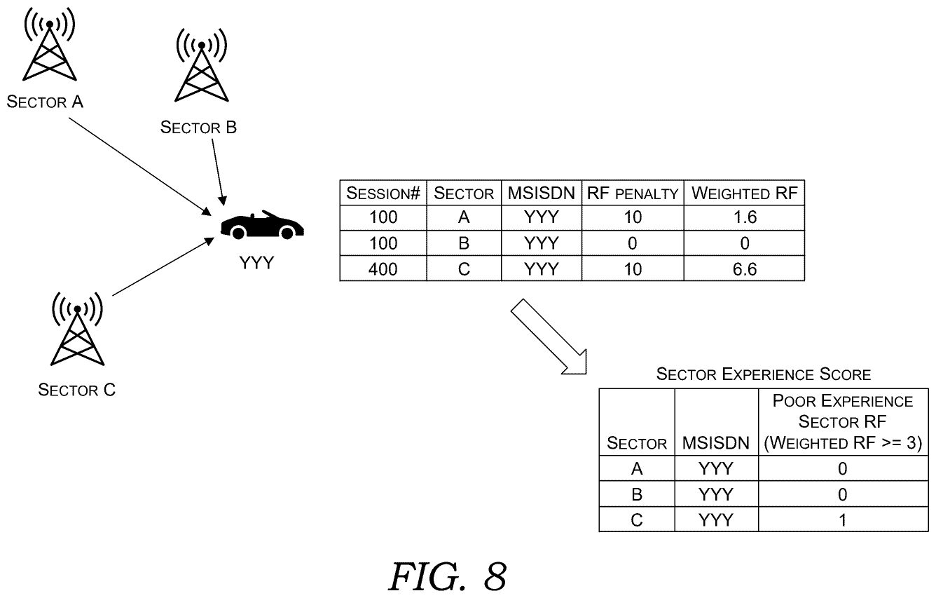

If the aggregation of the weighted score is performed at the sector level, it becomes possible to count the number of subscriber UEs experiencing poor RF conditions within that sector. This aggregated metric, referred to as the Sector Experience Score, is illustrated in FIG. 8. By identifying every UE with a weighted score exceeding a threshold, network operators may determine the extent of bad user experiences in a specific sector. For example, as illustrated in FIG. 8, a weighted score of 3 is used to identify subscribers with bad experiences. This score corresponds to subscribers experiencing poor performance for at least 30% of the time within the sector. The aggregating component 110 may calculate the Sector Experience Score by aggregating the weighted scores for all UEs served by a sector. Based on this analysis, the technology layer determining component 114 may recommend sector-level adjustments, such as reallocating bandwidth to higher performing technology layers or redistributing UEs to adjacent sectors to balance network load. For example, if a sector shows a high percentage of UEs with poor RF conditions, bandwidth may be dynamically reallocated from LTE to 5G-SA to improve overall sector performance.

The aggregating component 110 may calculate the Sector Experience Score by combining the weighted RF scores for all UEs in a given sector. This weighted sector score indicates the proportion of time a UE experiences suboptimal RF conditions while operating within the network sector. In this way, this score may reflect the overall quality of service within the sector. The identifying component 112 may identifying areas with a significant concentration of UEs with user experience metrics below a predetermined threshold. The identifying component may also use the score to identify one or more UEs within the network sector having a weighted score exceeding a predetermined threshold. Based on this analysis, the technology layer determining component 114 may recommend adjustments at the sector level, such as reallocating bandwidth from lower-performing technology layers like LTE to higher performing ones like 5G-SA, or activating a second technology layer wherein the Sector Experience Score or network sector weighted score of the second technology layer is different from the first technology layer.

The data weighing component 116 plays a critical role in calculating the Sector Experience Score by accurately aggregating the weighted RF scores across all UEs served by the sector. This ensures the score reflects the combined performance of all UEs in the sector, providing a comprehensive view of overall sector quality. Based on this analysis, the technology layer determining component 114 may identify technology layer adjustments for the sector to address poor RF conditions. For example, if the sector Experience Score indicates a significant portion of UEs are experiencing suboptimal performance, the technology layer determining component 114 may recommend rebalancing network resources, such as allocating additional bandwidth to a higher-performing technology layer.

The activation component 118 may be responsible for implementing the transition of UEs to the optimal technology layer as determined by the technology layer determining component 114. For example, when a UE is identified as experiencing poor RF conditions on LTE, the activation component 118 may transition the UE to 5G-NSA or 5G-SA, depending on the UE's capability and prevailing RF conditions. This transition may involve reallocating bandwidth resources, updating primary cell assignments, and reconfiguring uplink and downlink parameters to ensure seamless connectivity and minimal service disruption. Additionally, UEs may be redistributed to adjacent sectors with lower congestion to balance network load and optimize resource utilization. These adjustments are implemented by the activation component 118.

Once the optimal technology adjustments are identified, the activation component 118 may implement the necessary changes with the sector to improve user experiences. This may include actions such as transitioning UEs from lower-performing technology layers (e.g., LTE) to more optimal ones (e.g., 5G-SA), redistributing bandwidth resources, or reconfiguring primary cell assignments to reduce congestion and improve RF conditions. Together, these components ensure the sector is dynamically optimized to deliver better performance, minimizing resource inefficiencies while enhancing user experience across all connected UEs.

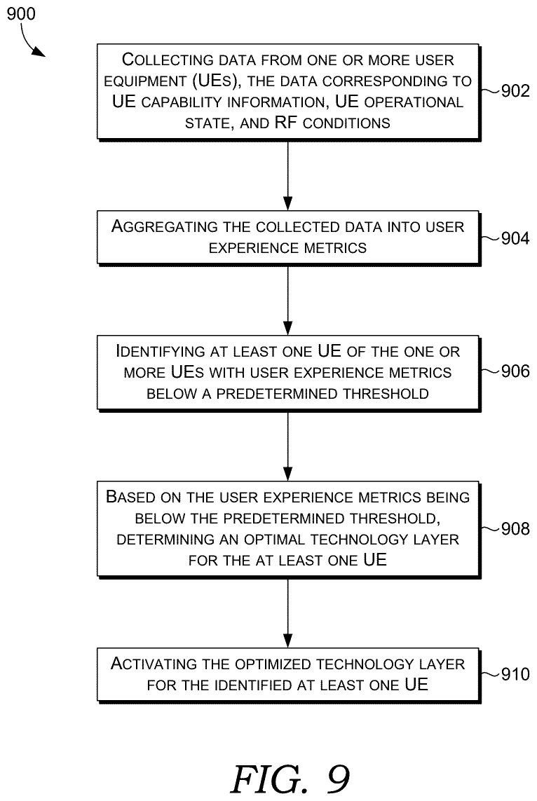

Turing now to FIG. 9, a flow chart representing a method 900 is provided. Generally, the method 900 may be used by a network for enabling optimization of user experience and user device performance. Step 902 is collecting data from one or more user equipment (UEs), the data corresponding to UE capability information, UE operational state, and RF conditions. Step 904 is aggregating the collected data into user experience metrics. Step 906 is identifying at least one UE of the one or more UEs with user experience metrics below a predetermined threshold. Step 908 is, based on the user experience metrics being below the predetermined threshold, determining an optimal technology layer for the at least one UE. Step 910 is activating the optimized technology layer for the identified at least one UE.

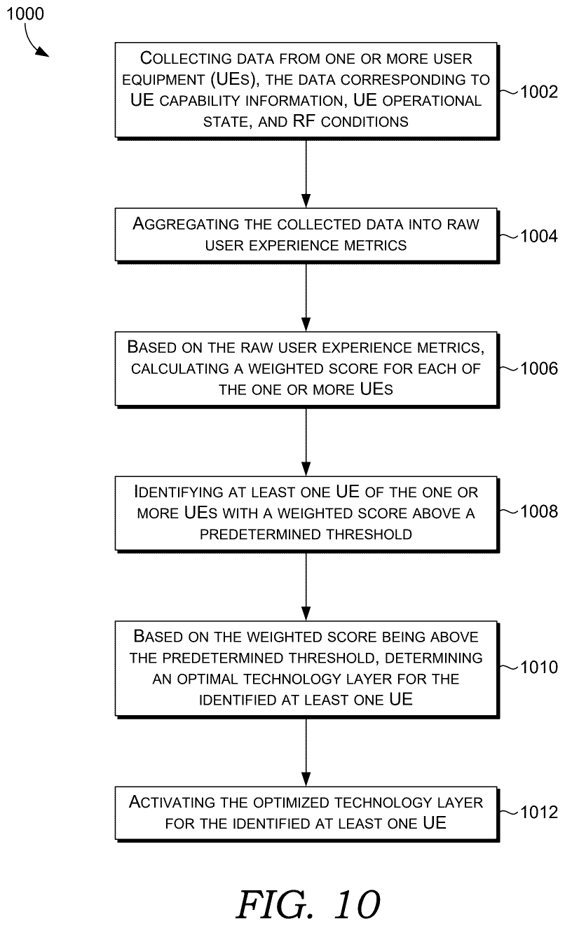

Turning now to FIG. 10, a flow chart representing a method 1000 is provided. Generally, the method 1000 may be used by a network for enabling optimization of user experience and user device performance. Step 1002 is collecting data from one or more user equipment (UEs), the data corresponding to UE capability information, UE operational state, and RF conditions. Step 1004 is aggregating the collected data into raw user experience metrics. Step 1006 is, based on the raw user experience metrics, calculating a weighted score for each of the one or more UEs. Step 1008 is identifying at least one UE of the one or more UEs with a weighted score above a predetermined threshold. Step 1010 is based on the weighted score being above the predetermined threshold, determining an optimal technology layer for the identified at least one UE. Step 1012 is activating the optimized technology layer for the identified at least one UE.

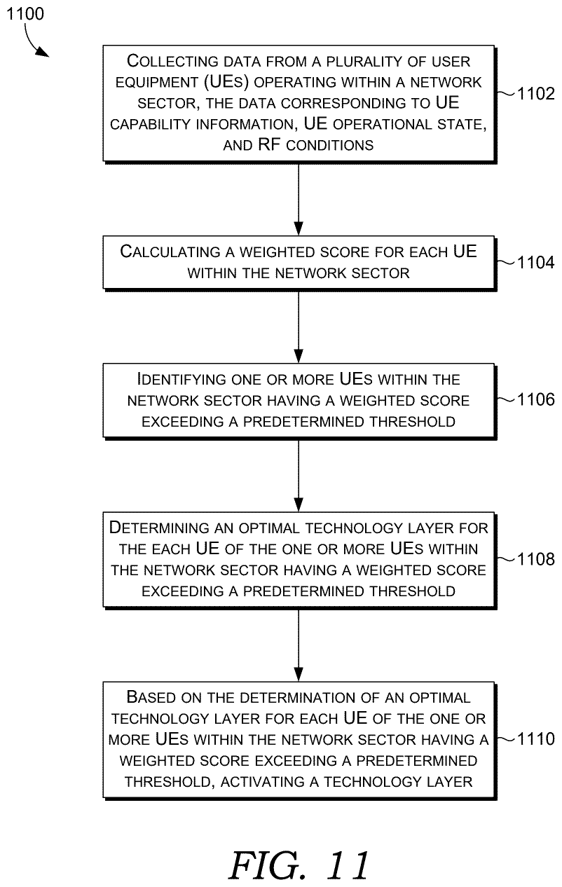

Turning now to FIG. 11, a flow chart representing a method 1100 is provided. Generally, the method 1000 may be used by a network for enabling optimization of user experience and user device performance. Step 1102 is collecting data from a plurality of user equipment (UEs) operating within a network sector, the data corresponding to UE capability information, UE operational state, and RF conditions. Step 1104 is calculating a weighted score for each UE within the network sector. Step 1106 is identifying one or more UEs within the network sector having a weighted score exceeding a predetermined threshold. Step 1108 is determining an optimal technology layer for the each UE of the one or more UEs within the network sector having a weighted score exceeding a predetermined threshold. Step 1110 is based on the determination of an optimal technology layer for each UE of the one or more UEs within the network sector having a weighted score exceeding a predetermined threshold, activating a technology layer.

Referring to FIG. 12, an exemplary computer environment is shown and designated generally as computing device 1200 that is suitable for use in implementations of the present disclosure. Computing device 1200 is but one example of a suitable computing environment and is not intended to suggest any limitation as to the scope of use or functionality of the invention. Neither should computing device 1200 be interpreted as having any dependency or requirement relating to any one or combination of components illustrated. In aspects, the computing device 1200 is generally defined by its capability to transmit one or more signals to an access point and receive one or more signals from the access point (or some other access point); the computing device 1200 may be referred to herein as a user equipment, wireless communication device, or user device. The computing device 1200 may take the form of a wireless access device that acts as a more localized and consolidated access point that provides end user wireless devices access to a broader network; examples of wireless access devices include fixed wireless access (FWA) devices and mobile hotspots. The computing device 1200 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) device (e.g., augmented reality (AR), virtual reality (VR), and mixed reality (MR)), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 1200 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 12, computing device 1200 includes bus 1202 that directly or indirectly couples the following devices: memory 1204, one or more processors 1206, one or more presentation components 1208, input/output (I/O) ports 1210, I/O components 1212, and power supply 1214. Bus 1202 represents what may be one or more busses (such as an address bus, data bus, or combination thereof). Although the devices of FIG. 12 are shown with lines for the sake of clarity, in reality, delineating various components is not so clear, and metaphorically, the lines would more accurately be grey and fuzzy. For example, one may consider a presentation component such as a display device to be one of I/O components 1212. Also, processors, such as one or more processors 1206, have memory. The present disclosure hereof recognizes that such is the nature of the art, and reiterates that FIG. 12 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 12 and refer to “computer” or “computing device.”

Computing device 1200 typically includes a variety of computer-readable media. Computer-readable media can be any available media that can be accessed by computing device 1200 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 1200 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1204 includes computer-storage media in the form of volatile and/or nonvolatile memory. Memory 1204 may be removable, nonremovable, or a combination thereof. Exemplary memory includes solid-state memory, hard drives, optical-disc drives, etc. Computing device 500 includes one or more processors 1206 that read data from various entities such as bus 1202, memory 1204 or I/O components 1212. One or more presentation components 1208 presents data indications to a person or other device. Exemplary one or more presentation components 1208 include a display device, speaker, printing component, vibrating component, etc. I/O ports 1210 allow computing device 1200 to be logically coupled to other devices including I/O components 1212, some of which may be built in computing device 1200. Illustrative I/O components 1212 include a microphone, joystick, game pad, satellite dish, scanner, printer, wireless device, etc.

A first radio 1220 and a second radio 1230 represent radios that facilitate communication with one or more wireless networks using one or more wireless links. In aspects, the first radio 1220 utilizes a first transmitter 1222 to communicate with a wireless network on a first wireless link and the second radio 1230 utilizes the second transmitter 1232 to communicate on a second wireless link. Though two radios are shown, it is expressly conceived that a computing device with a single radio (i.e., the first radio 1220 or the second radio 1230) could facilitate communication over one or more wireless links with one or more wireless networks via both the first transmitter 1222 and the second transmitter 1232. Illustrative wireless telecommunications technologies include CDMA, GPRS, TDMA, GSM, 802.11, and the like. One or both of the first radio 1220 and the second radio 1230 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 1220 and the second radio 1230 may be configured to communicate using the same protocol but in other aspects they may be configured to communicate using different protocols. In some embodiments, including those that both radios or both wireless links are configured for communicating using the same protocol, the first radio 1220 and the second radio 1230 may be configured to communicate on distinct frequencies or frequency bands (e.g., as part of a carrier aggregation scheme). As can be appreciated, in various embodiments, each of the first radio 1220 and the second radio 1230 can be configured to support multiple technologies and/or multiple frequencies; for example, the first radio 1220 may be configured to communicate with a base station according to a cellular communication protocol (e.g., 4G, 5G, 6G, or the like), and the second radio 1230 may configured to communicate with one or more other computing devices according to a local area communication protocol (e.g., IEEE 802.11 series, Bluetooth, NFC, z-wave, or the like).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

1. A method for enabling optimization of user experience and user device performance, the method comprising:
collecting data from one or more user equipment (UEs), the data corresponding to UE capability information, UE operational state, and RF conditions;
aggregating the collected data into user experience metrics;
identifying at least one UE of the one or more UEs with user experience metrics below a predetermined threshold;
based on the user experience metrics being below the predetermined threshold, determining an optimal technology layer for the at least one UE; and
activating the optimized technology layer for the identified at least one UE.

2. The method according to claim 1, wherein the one or more UEs are utilizing a Long-Term-Evolution (LTE) technology layer.

3. The method according to claim 2, wherein the optimized technology layer for the at least one UE is one of a 5G standalone (5G SA) technology layer or a 5G non-standalone (5G NSA) technology laer.

4. The method of claim 1, wherein the first technology layer is non-standalone 5G (NSA) and the second technology layer is 5G standalone (5G SA).

5. The method according to claim 1, wherein the user experience metrics are weighted based on a number of sessions conducted by the one or more UEs.

6. The method according to claim 1, wherein the RF conditions include reference signal received power (RSRP) and signal-to-noise ratio (SINR) measurements for each of the one or more UEs.

7. The method according to claim 1, wherein the optimal technology layer is determined based on a comparison of uplink signal strength thresholds to downlink signal strength thresholds.

8. The method according to claim 1, wherein the UE capability information is established by aggregating Location Service Records (LSRs) of the one or more of UEs.

9. The method according to claim 8, wherein the LSRs are collected at a session level, and wherein a maximum capability of each of the one or more UEs is established by monitoring session technology mode information for each session.

10. The method according to claim 8, wherein the LSRs allow a network to analyze operation of the network at a UE level instead of a node level.

11. A method for enabling optimization of user experience and user device performance, the method comprising:
collecting data from one or more user equipment (UEs), the data corresponding to UE capability information, UE operational state, and RF conditions;
aggregating the collected data into user experience metrics;
based on the user experience metrics, calculating a weighted score for each of the one or more UEs, wherein the weighted score is calculated based on a combination of RF conditions and operational state metrics for each UE of the one or more UEs;
identifying at least one UE of the one or more UEs with a weighted score above a predetermined threshold;
based on the weighted score being above the predetermined threshold, determining an optimal technology layer for the identified at least one UE;
activating the optimized technology layer for the identified at least one UE; and
dynamically adjusting the predetermined threshold based on overall network performance metrics.

12. The method according to claim 11, wherein the plurality of UEs utilize a first technology layer.

13. The method according to claim 11, wherein the optimized technology layer for the at least one UE is a second technology layer.

14. The method according to claim 11, wherein the weighted score defines a percentage of time the one or more UEs user experience metrics fall below a predetermined threshold.

15. A method for enabling optimization of user experience and user device performance, the method comprising:
collecting data from a plurality of user equipment (UEs) operating within a network sector, the data corresponding to UE capability information, UE operational state, and RF conditions;
calculating a weighted score for each UE within the network sector;
identifying one or more UEs within the network sector having a weighted score exceeding a predetermined threshold;
determining an optimal technology layer for the each UE of the one or more UEs within the network sector having a weighted score exceeding a predetermined threshold; and
based on the determination of an optimal technology layer for each UE of the one or more UEs within the network sector having a weighted score exceeding a predetermined threshold, activating a technology layer.

16. The method according to claim 15, wherein the plurality of UEs are utilizing a first technology layer.

17. The method according to claim 16, wherein the optimal technology layer for the each UE of the one or more UEs within the network sector having a weighted score exceeding a predetermined threshold is different from the first technology layer.

18. The method of claim 15, wherein the weighted score indicates the proportion of time a UE experiences suboptimal RF or operational conditions while operating within the network sector.

19. The method according to claim 15, wherein activating the technology layer includes reallocating bandwidth resources within the network sector.

20. The method according to claim 15, further comprising aggregating the weighted scores for each UE within the network sector to evaluate overall sector performance.
